(19) United States
(12) Patent Application Publication
(10) Pub. No.: US 2016/0073035 A1
(43) Pub. Date: Mar. 10, 2016

(54) ELECTRONIC APPARATUS AND NOTIFICATION CONTROL METHOD

(71) Applicant: Kabushiki Kaisha Toshiba, Tokyo (JP)

(72) Inventor: Koji Yamamoto, Ome Tokyo (JP)

(21) Appl. No.: 14/942,739

(22) Filed: Nov. 16, 2015

Related U.S. Application Data
(63) Continuation of application No. PCT/JP2013/072740, filed on Aug. 26, 2013.

(51) Int. Cl. H04N 5/232

(52) U.S. Cl. CPC H04N 5/23293; H04N 5/23229; H04N 5/23222

(57) ABSTRACT

According to one embodiment, an electronic apparatus includes a processor. The processor detects a first region of a first image where a glare occurs, the first image including a subject. The processor notifies a user of information based on the first region to determine a capturing position of the subject when a preview image of the subject captured with a camera is displayed on a screen.

### CROSS REFERENCE TO RELATED APPLICATIONS

This application is a Continuation application of PCT Application No. PCT/JP2013/072740, filed Aug. 26, 2013, the entire contents of which are incorporated herein by reference.

### FIELD

Embodiments described herein relate generally to an electronic apparatus capable of capturing images and a notification control method applied to the apparatus.

### BACKGROUND

Recently, various electronic apparatuses capable of capturing images, such as personal computers, PDAs, mobile phones, and smartphones, which are equipped with a camera, and digital cameras have become widespread.

These electronic apparatuses are used to capture not only images of people or scenery, but also material printed in magazines, written in notebooks, etc., or posted on bulletin boards, etc. Images generated by the capturing are used to be saved as an archive of a personal record, for example, or viewed by people.

Meanwhile, with a subject such as a whiteboard whose surface is likely to be reflected, the glare caused by the reflection of the subject sometimes occurs. In an image including such a subject photographed, depending on the glare, information on the subject (for example, characters written on the whiteboard) may be missing.

Accordingly, a method of using images in which the subject is captured from various positions to acquire an image in which the glare is reduced has been proposed.

However, for example, it is quite likely that further photographing the subject from a position where the glare can be reduced while completely ascertaining the place of the glare in the captured image will be a troublesome task for the user. Accordingly, there are situations where efficient acquisition of images whereby the glare in the image can be reduced is expected.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic apparatus according to an embodiment.

FIG. 2 is an exemplary block diagram showing a system configuration of the electronic apparatus of the embodiment.

FIG. 3 is an illustration for describing an example of generating an image in which the glare is reduced by the electronic apparatus of the embodiment.

FIG. 4 is a block diagram showing an example of a functional configuration of an image processing program executed by the electronic apparatus of the embodiment.

FIG. 5 is an illustration for describing a first example of notification based on the glare in a captured image (a criterion image) by the electronic apparatus of the embodiment.

FIG. 6 is an illustration for describing a second example of notification based on the glare in a captured image (a criterion image) by the electronic apparatus of the embodiment.

FIG. 7 is an illustration for describing a third example of notification based on the glare in a captured image (a criterion image) by the electronic apparatus of the embodiment.

FIG. 8 is an illustration for describing a fourth example of notification based on the glare in a captured image (a criterion image) by the electronic apparatus of the embodiment.

FIG. 9 is an illustration for describing an example of generating an image in which the glare is reduced from a criterion image and a reference image by the electronic apparatus of the embodiment.

FIG. 10 is a flowchart showing an example of the procedure of glare reduction process executed by the electronic apparatus of the embodiment.

FIG. 11 is a flowchart showing another example of the procedure of glare reduction process executed by the electronic apparatus of the embodiment.

FIG. 12 is a flowchart showing yet another example of the procedure of glare reduction process executed by the electronic apparatus of the embodiment.

### DETAILED DESCRIPTION

Various embodiments will be described hereinafter with reference to the accompanying drawings.

In general, according to one embodiment, an electronic apparatus includes a processor. The processor is configured to detect a first region of a first image where a glare occurs, the first image including a subject. The processor notifies a user of information based on the first region to determine a capturing position of the subject when a preview image of the subject captured with a camera is displayed on a screen.

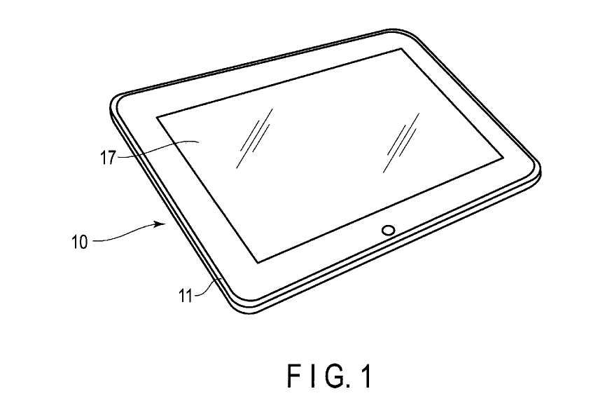

FIG. 1 is a perspective view showing an appearance of an electronic apparatus according to an embodiment. The electronic apparatus can be realized as tablet computers, notebook personal computers, smartphones, PDAs, or an embedded system which can be incorporated into various electronic apparatuses such as digital cameras. In the following descriptions, a case where the electronic apparatus is realized as a tablet computer 10 is assumed. The tablet computer 10 is a portable electronic apparatus which is also referred to as a tablet or a slate computer. The tablet computer 10 includes a main body 11 and a touchscreen display 17, as shown in FIG. 1. The touchscreen display 17 is arranged to be laid over a top surface of the main body 11.

The main body 11 includes a thin box-shaped housing. In the touchscreen display 17, a flat-panel display, and a sensor configured to detect a contact position of the stylus or the finger on a screen of the flat-panel display are incorporated. The flat-panel display may be, for example, a liquid crystal display (LCD). As the sensor, a capacitive touchpanel or an electromagnetic induction-type digitizer, for example, can be used.

In addition, in the main body 11, a camera module for capturing an image from the side of the lower surface (back surface) of the main body 11 is provided.

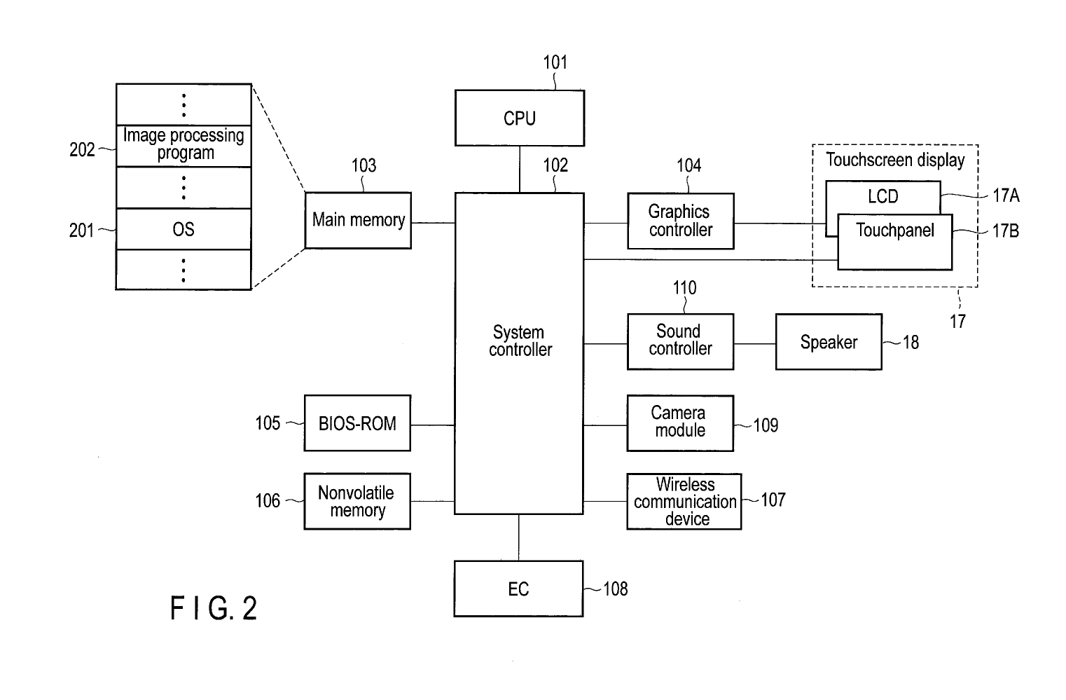

FIG. 2 is a diagram showing a system configuration of the tablet computer 10.

As shown in FIG. 2, the tablet computer 10 includes a CPU 101, a system controller 102, a main memory 103, a graphics controller 104, a BIOS-ROM 105, a nonvolatile memory 106, a wireless communication device 107, an embedded controller (EC) 108, a camera module 109, a sound controller 110, etc.

The CPU 101 is a processor for controlling the operation of various modules in the tablet computer 10. The CPU 101 executes various kinds of software loaded into the main memory 103 from the nonvolatile memory 106, which is a storage device. These kinds of software include an operating system (OS) 201, and various application programs. The application programs include an image processing program 202. The image processing program 202 has the function of reducing the glare on a subject which is included in an image captured with the camera module 109, for example.

Further, the CPU 101 executes a Basic Input/Output System (BIOS) stored in the BIOS-ROM 105. The BIOS is a program for controlling hardware.

The system controller 102 is a device for connecting between a local bus of the CPU 101 and the various components. In the system controller 102, a memory controller for access controlling the main memory 103 is also integrated. Also, the system controller 102 has the function of communicating with the graphics controller 104 via a serial bus conforming to the PCI EXPRESS standard.

The graphics controller 104 is a display controller for controlling an LCD 17A which is used as a display monitor of the tablet computer 10. A display signal generated by the graphics controller 104 is transmitted to the LCD 17A. The LCD 17A displays a screen image based on the display signal. A touchpanel 17B is arranged on the LCD 17A.

Further, the system controller 102 has the function of executing communication with the sound controller 110. The sound controller 110 is a sound source device, and outputs audio data to be played to a speaker 18.

The wireless communication device 107 is a device configured to execute wireless communication such as a wireless LAN or 3G mobile communication. The EC 108 is a one-chip microcomputer including an embedded controller for power management. The EC 108 has the function of powering the tablet computer 10 on or off in accordance with the power button operation by the user.

The camera module 109 captures an image as the user touches (taps) a button (a graphical object) displayed on a screen of the touchscreen display 17, for example. The camera module 109 can also capture sequential images such as a moving image.

Incidentally, when a subject which is likely to have the glare by reflection, such as a whiteboard or glossy paper, is photographed with the camera module 109, the so-called flared highlights (halation) caused by sunlight or a fluorescent lamp in a room are sometimes exhibited in the captured image. In a region in which the flared highlights are exhibited in the image, there is a possibility that a character or a figure written on the whiteboard, for example, will be missed.

Accordingly, in the present embodiment, by using images that are generated by photographing the subject from different positions or angles, that is, by using images which have the flared highlights (the glare) at different positions in the image, an image in which the glare is reduced is generated.

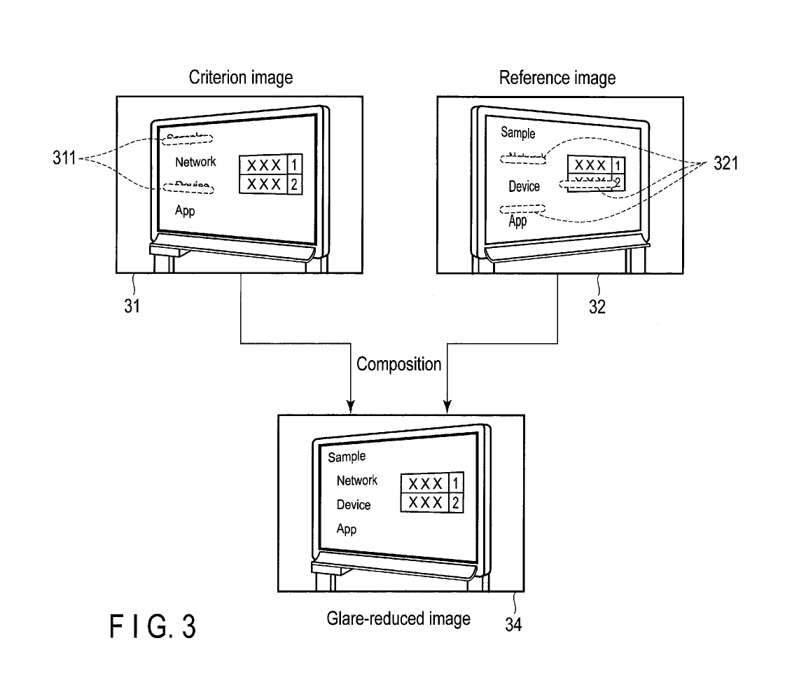

FIG. 3 shows an example of creating an image in which the glare is reduced by using two images having the glare at different positions in the images.

Images 31 and 32 are generated by photographing a subject (for example, a whiteboard). The image 31 (hereinafter also referred to as a criterion image) includes glare (that is, flared highlights) 311 by reflection. Also, the image 32 (hereinafter also referred to as a reference image) has glare 321 at a position different from the glare 311 in the criterion image 31 since the subject is photographed at a position different from where the criterion image 31 was captured, for example.

In the present embodiment, the criterion image 31 and the reference image 32 are combined by using pixels that are not involved with the glare 311 among pixels of the criterion image 31 and pixels that are not involved with the glare 321 among pixels of the reference image 32. Thereby an image 34 in which the glare is reduced can be created.

Meanwhile, in capturing the reference image 32 after capturing the criterion image 31, it is quite likely that photographing the subject from a position where the glare 311 can be reduced while completely ascertaining the place of the glare 311 in the criterion image 31 will be a troublesome task for the user. For example, when an angle with respect to the subject has been changed as a result of moving the camera module 109, the appearance of the subject in the image (a preview image) captured by the camera module 109 changes. Accordingly, it may be difficult for the user to ascertain which part of the preview image (the reference image 32) the glare 311 in the criterion image 31 corresponds to.

Accordingly, in the present embodiment, in order to enable an image for reducing the glare 311 captured in the criterion image 31 to be efficiently acquired, information for determining a next position for photographing the subject is notified to the user.

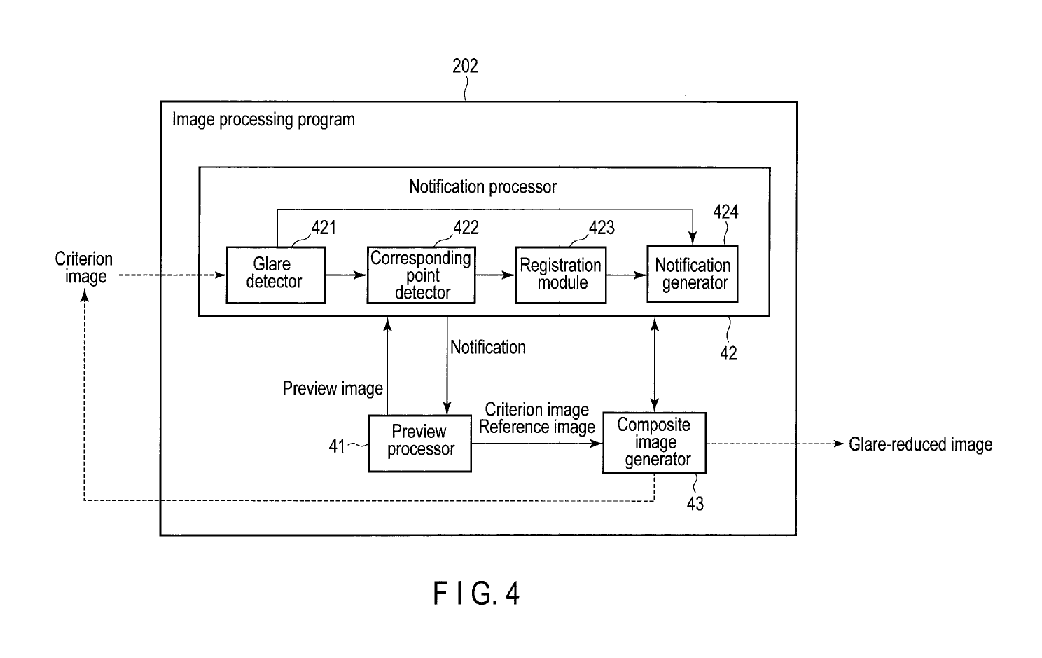

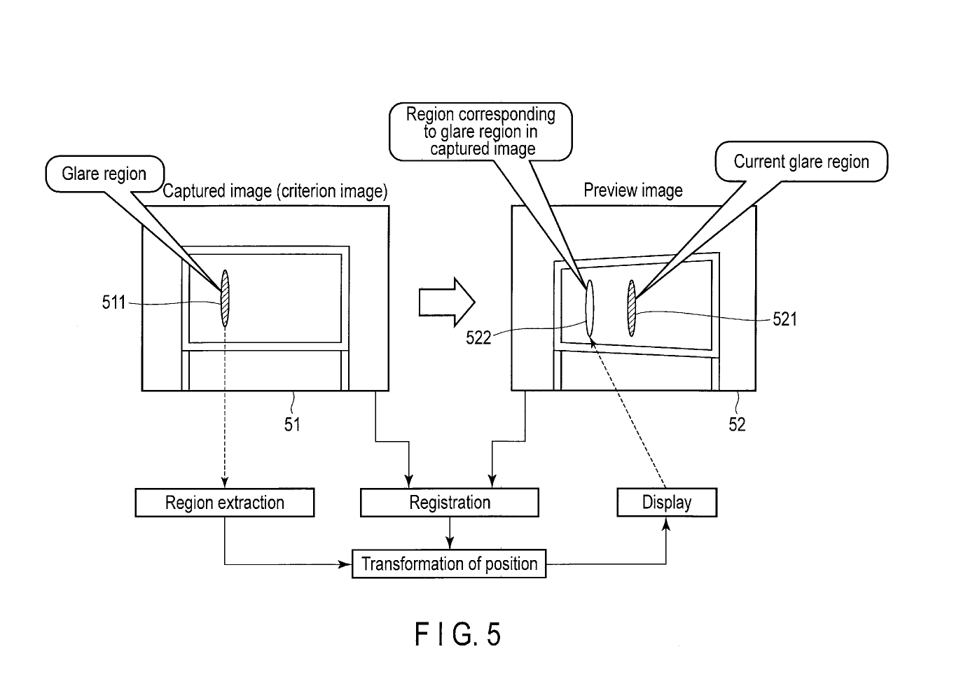

Referring to FIG. 4, a functional configuration of the image processing program 202 which is executed by the tablet computer 10 will be described. The image processing program 202 has the function of generating an image in which the glare is reduced, and the function of assisting acquiring of an image for reducing the glare. In the following, as shown in FIG. 5, a case where a criterion image 51 in which a subject (for example, a whiteboard) is photographed is already produced by the camera module 109 is assumed. The criterion image 51 is produced by the camera module 109 in accordance with the instruction of image capturing given by the user, for example.

The image processing program 202 includes, for example, a preview processor 41, a notification processor 42, a composite image generator 43, etc. The preview processor 41 preview-displays an image (hereinafter also referred to as a preview image) 52 that is being captured by the camera module 109. The preview processor 41 sequentially displays images which are consecutively generated by, for example, the camera module 109 on screen.

The notification processor 42 notifies information for determining a position for photographing the subject to the user based on a region (a first region) in which glare 511 is exhibited within the criterion image 51 while a preview image 52 is being displayed. That is, the notification processor 42 outputs a notification which assists the acquiring of a reference image for reducing the glare region 511 in the criterion image 51. For example, the notification processor 42 displays the glare region 511 in the criterion image 51 at a corresponding region 522 in the preview image 52. The notification processor 42 includes a glare detector 421, a corresponding point detector 422, a registration module 423, and a notification generator 424.

The glare detector 421 detects the glare region 511 from the criterion image 51. For example, the glare detector 421 estimates whether a certain pixel in the image is involved with occurrence of flared highlights caused by the glare and calculates an evaluated value based on the estimated result. With respect to this evaluated value, the higher the possibility of occurrence of the flared highlights (the glare) is, for example, the smaller evaluated value will be set. In other words, the lower the possibility of occurrence of the glare is, and the more the image is suitable for reducing the glare, the higher evaluated value will be set. The glare detector 421 calculates first evaluated values corresponding to the pixels in the criterion image 51, and detects a pixel having an evaluated value, which is less than a threshold value, as being involved with the glare.

The corresponding point detector 422 detects feature points in the criterion image 51. The feature point indicates a corner or the like in the image which has been detected by using a local feature that is robust against rotation or deformation of the subject in the image, such as scale-invariant feature transform (SIFT) or speeded up robust features (SURF), and multiple feature points may be detected from an image. The corresponding point detector 422 also detects feature points in the preview image 52 in the same way as for the criterion image 51.

Next, the corresponding point detector 422 detects corresponding points between the criterion image 51 and the preview image 52. The corresponding point detector 422 detects a feature point in the reference image 52 corresponding to the feature point in the criterion image 51 by using the feature points detected from the criterion image 51 and the preview image 52, thereby detecting corresponding points between the criterion image 51 and the preview image 52.

The registration module 423 aligns the criterion image 51 with the preview image 52 based on the detected corresponding points. More specifically, the registration module 423 calculates transformation coefficients (for example, projective transformation coefficients) for making the position of the feature point in the criterion image 51 match with the position of the corresponding feature point in the preview image 52, by using the corresponding points. The registration module 423 estimates the transformation coefficients from the corresponding points by using, for example, a least square method or random sample consensus (RANSAC).

The notification generator 424 transforms the glare region 511 in the criterion image 51 into the corresponding region 522 in the preview image 52 based on the corresponding points of the criterion image 51 and the preview image 52. More specifically, the notification generator 424 projectively transforms the glare region 511 in the criterion image 51 into the corresponding region 522 in the preview image 52, based on the projective transformation coefficients calculated by using the corresponding points. Note that the transformation is not limited to the projective transformation, and may be affine transformation, parallel translation, etc. Further, the notification generator 424 displays the region 522 which corresponds to the glare region 511 in the criterion image 51 and is superimposed on the preview image.

In this way, the user can confirm that the position of the glare region 511 in the criterion image 51 corresponds to the position of the region 522 in the preview image 52. Accordingly, by confirming the region 522 in the preview image 52 corresponding to the glare 511, the user can easily move the camera module 109 (the tablet computer 10 in which the camera module 109 is incorporated) such that the glare 511 in the criterion image 51 does not overlap with glare 521 currently occurred in the preview image 52. The user instructs capturing (generation) of a reference image (for example, presses a button for instructing the image capturing) at an image capturing position where the glare 511 in the criterion image 51 and the glare 521 currently occurred in the preview image 52 do not overlap one another. The camera module 109 generates a reference image including the subject in response to this instruction. In this way, the reference image for acquiring a glare-reduced image can be efficiently obtained.

Note that the preview image 52 that is being displayed is updated in accordance with an update rate of images by the camera module 109, for example. Each of the modules of the image processing program 202 is configured such that a notification for assisting the acquiring of the reference image (for example, the display of the region 522 in the preview image 52 corresponding to the glare 511 in the criterion image 51) is also updated in accordance with the update of the preview image 52. Further, after the criterion image 51 and the preview image 52 have been registered (that is, after transformation coefficients of the criterion image 51 and the preview image 52 have been calculated), the registration module 423 may track the corresponding region 522 in the preview image 52, which is the region corresponding to the glare 511 in the criterion image 51, for every update of the preview image 52. Because of this tracking, since the registration of the entire image does not need to be performed, the amount of computation can be reduced.

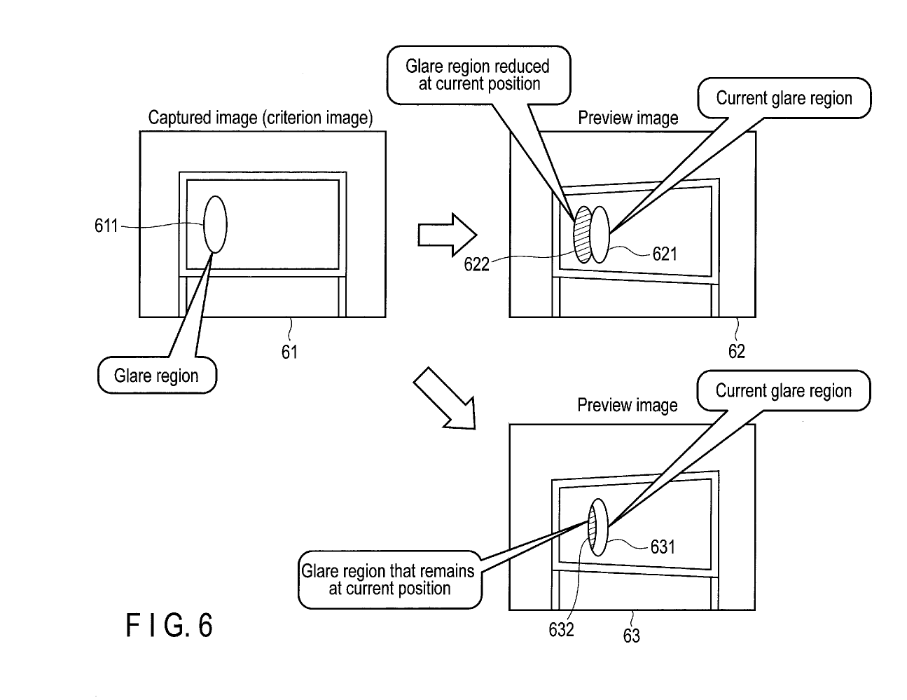

Further, FIG. 6 shows another two examples of notification during preview display. Here, it is assumed that a glare region 611 is included in a captured image (a criterion image) 61.

In the first example, a region 622 in which the glare is to be reduced by the preview image 62, of a transformed glare region (a third region) in which the glare region 611 (a first region) in the criterion image 61 is transformed into a corresponding region in the preview image 62, is displayed in the preview image 62. That is, of the transformed glare region (third region), a region which does not overlap with a glare region 621 (second region) in the preview image 62 is displayed as the region 622 in which the glare is reduced by the preview image 62.

In the first example, the glare detector 421 detects the glare region 611 (first region) from the criterion image 61, and detects the glare region 621 (second region) from the preview image 62. The corresponding point detector 422 also detects the corresponding points between the criterion image 61 and the preview image 62. Further, the registration module 423 calculates transformation coefficients for making the position of the feature point in the criterion image 61 match with the position of the corresponding feature point in the preview image 62 (that is, transformation coefficients for registering the criterion image 61 and the preview image 62), based on the detected corresponding points.

Next, the notification generator 424 transforms the glare region 611 (first region) in the criterion image 61 into the corresponding region (third region) in the preview image 62 by using the calculated transformation coefficients. The notification generator 424 detects a region which does not overlap with the glare 621 (second region) currently displayed in the preview image 62, of the region (third region) in the preview image 62 corresponding to the glare 611 in the criterion image 61. The detected region corresponds to the region 622 in which the glare is reduced by the preview image 62 as described above. The notification generator 424 displays the region 622 in which the glare is reduced by the preview image 62. The region is superimposed on the preview image 62.

In the second example, a region 632 in which the glare remains (that is, the glare is not reduced) even if a preview image 63 is used, of a transformed glare region (third region) in which the glare region 611 (first region) in the criterion image 61 is transformed into a corresponding region in the preview image 63, is displayed in the preview image 63. That is, of the transformed glare region (third region), a region which overlaps with a glare region 631 (second region) in the preview image 63 is displayed as the region 632 in which the glare remains even if the preview image 63 is used.

Even in the case of the second example, as in the first example described above, the glare 611 (first region) in the criterion image 61 is transformed into the corresponding region (third region) in the preview image 63. The notification generator 424 detects a portion which overlaps the glare 631 (second region) currently occurred in the preview image 63, of the region (third region) in the preview image 63 corresponding to the glare 611 (first region) in the criterion image 61. The detected portion corresponds to the region 632 in which the glare remains even if the preview image 63 is used as described above. Further, the notification generator 424 displays the region 632 in which the glare remains even if the preview image 63 is used. The region is superimposed on the preview image 63.

Note that the notification generator 424 may combine these two types of notification so that the region 622 in which the glare is reduced and the region 632 in which the glare remains are displayed together. Further, the notification generator 424 may display each of the region 622 in which the glare is reduced and the region 632 in which the glare remains in specific colors or specific transparency, for example. In addition, these regions 622 and 632 may be blinked in specific patterns. In this way, the region 622 in which the glare is reduced and the region 632 in which the glare remains can be displayed in such a way that they can be easily distinguished by the user.

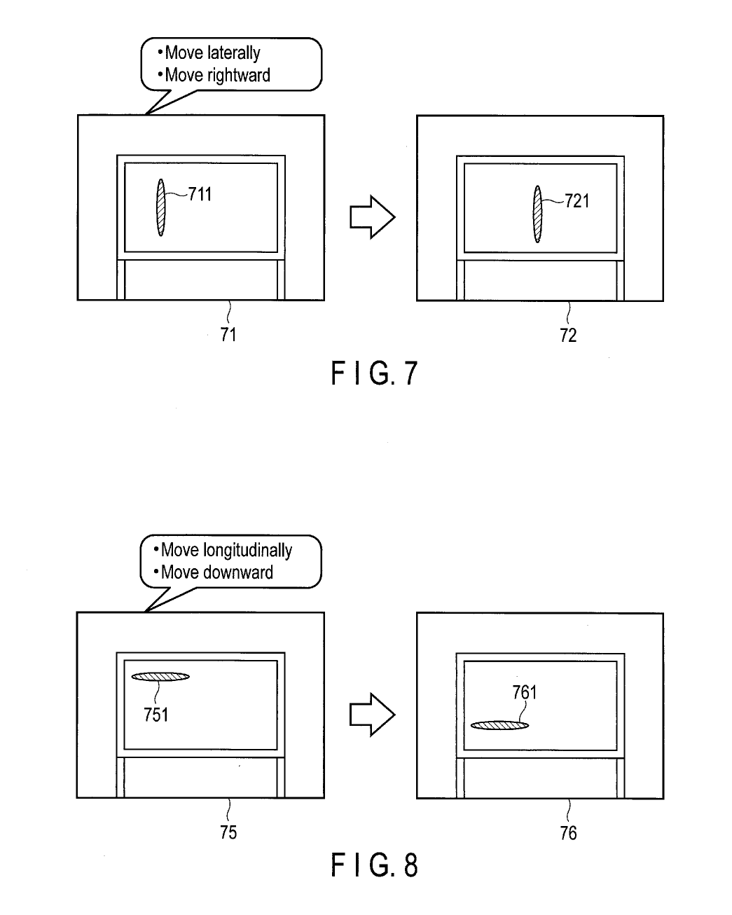

Further, as shown in FIGS. 7 and 8, while the preview image is being displayed, the direction in which the camera 109 should be moved may be notified in order to assist the acquiring of a reference image for reducing the glare in the criterion image.

In the example shown in FIG. 7, when vertically extending glare 711 is included in a criterion image 71, a notification is given by using voice or a GUI element to move the camera 109 in the horizontal direction (leftward or rightward) so that this vertically extending glare 711 is reduced. The vertically extending glare 711 has a shape in which the size (length) in the vertical direction is greater than the size (length) in the horizontal direction. Since the vertically extending glare 711 is shown on the left side of the criterion image 71, a notification is given to move the camera 109 so that the glare 711 is shown more to the right side, for example, that is, the glare is shown as glare 721 in a preview image 72.

Further, in the example shown in FIG. 8, when horizontally extending glare 751 is included in a criterion image 75, a notification is given by using voice or a GUI element to move the camera 109 in the vertical direction (upward or downward) so that this horizontally extending glare 751 is reduced. The horizontally extending glare 751 has a shape in which the size in the horizontal direction is greater than the size in the vertical direction. Since the horizontally extending glare 751 is shown on the upper side of the criterion image 75, a notification is given to move the camera 109 so that the glare 751 is shown more to the lower side, for example, that is, the glare is shown as glare 761 in a preview image 76.

The image processing program 202 is operated as described below in order to realize the examples shown in FIGS. 7 and 8.

Firstly, the glare detector 421 detects the glare regions 711, 751 from the criterion images 71, 75. The glare detector 421 detects the size of the detected glare region 711, 751 in the vertical direction, and the size of the detected glare region 711, 751 in the horizontal direction.

The notification generator 424 gives a notification suggesting that the camera (camera module) 109 should be moved horizontally in the case where the size of the glare region 711, 751 in the vertical direction is greater than the size of the glare region 711, 751 in the horizontal direction. For example, the notification generator 424 outputs voice from the speaker 18 instructing that the camera should be moved horizontally. The notification generator 424 may display various kinds of GUI elements such as text or an image (figure) of an arrow on screen to instruct that the camera should be moved horizontally.

Further, when the size of the glare region 711, 751 in the vertical direction is less than the size of the glare region 711, 751 in the horizontal direction (or the size of the glare region 711, 751 in the vertical direction is smaller than or equal to the size of the glare region 711, 751 in the horizontal direction), the notification generator 424 gives a notification suggesting that the camera (camera module) 109 should be moved vertically. For example, the notification generator 424 outputs voice from the speaker 18 instructing that the camera should be moved vertically. The notification generator 424 may display various kinds of GUI elements such as text or an image of an arrow on screen to instruct that the camera should be moved vertically.

The notification generator 424 may further give a notification that the glare region 711, 751 should be moved in the opposite direction from where the glare region 711, 751 is currently positioned (for example, when the glare region 711, 751 is on the left side of the corresponding criterion image 71, 75, a notification to move it to the right), based on the position of the glare in the criterion image 71, 75 where the glare region 711, 751 exists.

The user moves the camera 109 in accordance with the notification using voice output or display as described above, and instructs capturing of a reference image at that position. The camera module 109 generates a reference image including the subject in response to this instruction. In this way, the reference image for acquiring a glare-reduced image can be efficiently obtained.

The composite image generator 43 combines the criterion image and the acquired reference image, thereby creating the glare-reduced image. For example, the composite image generator 43 aligns the reference image with the criterion image in cooperation with the glare detector 421, the corresponding point detector 422 and the registration module 423, and generates the glare-reduced image by alpha-blending the criterion image and the aligned reference image.

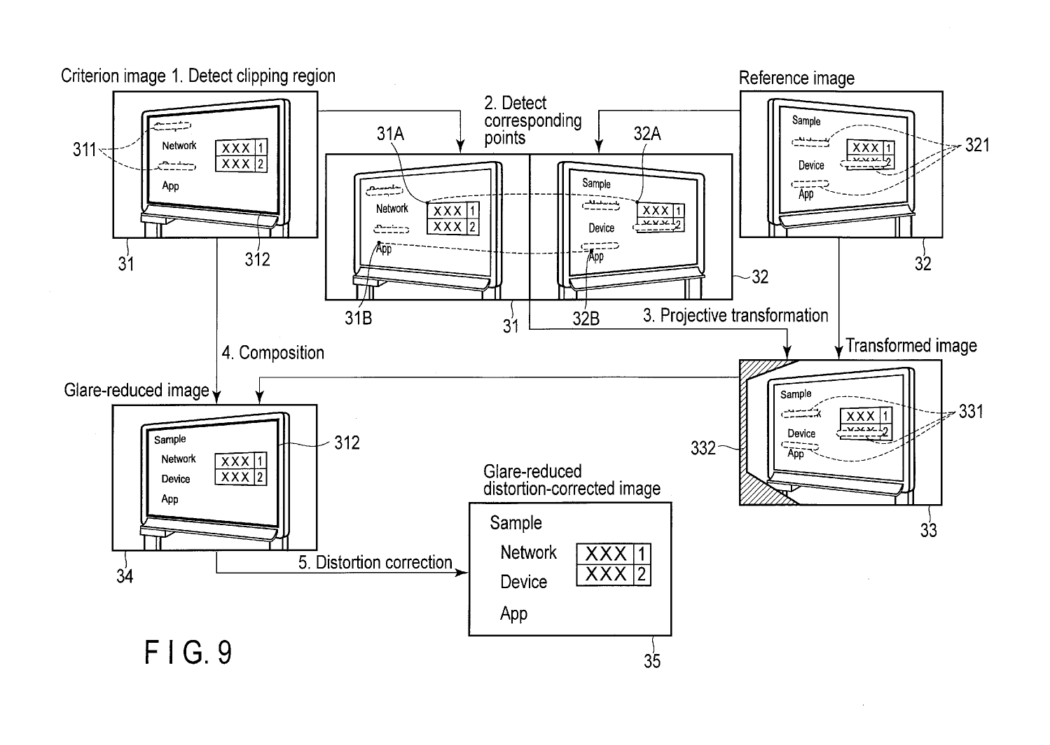

With reference to FIG. 9, an example of the case where a glare-reduced image is generated by using the criterion image 31 and the reference image 32 will be described. In the example shown in FIG. 9, the glare (the flared highlights) 311 caused by reflection is exhibited in the criterion image 31, and the glare 321 is exhibited in the reference image 32 at a position different from the position of the glare 311 in the criterion image 31.

The composite image generator 43 detects a clipping region 312 corresponding to a region extracted as an output image from the criterion image 31. For example, the composite image generator 43 detects edges within the criterion image 31 by using pixels values (intensity values) of pixels in the criterion image 31. Further, the composite image generator 43 detects the largest rectangle, which is constituted by the detected edges, as the clipping region 312. In this way, a region in which the whiteboard (subject) is shown in the criterion image 31 can be detected as the clipping region 312.

The corresponding point detector 422 and the registration module 423 align the reference image 32, which includes the subject (for example, the whiteboard) photographed from a position different from where the criterion image 31 was captured, with the criterion image 31 including this subject. That is, the corresponding-point detector 422 and the registration module 423 align with the criterion image 41 in one view of a subject the reference image 42 in another view of the subject. The corresponding point detector 422 and the registration module 423 align the reference image 32 such that the positions of pixels in the reference image 32 match with the positions of the corresponding pixels in the criterion image 31.

Firstly, the corresponding point detector 422 detects corresponding points of the criterion image 31 and the reference image 32. More specifically, the corresponding point detector 422 detects feature points from the criterion image 31 and the reference image 32, respectively. The corresponding point detector 422 detects a feature point in the reference image 32 corresponding to the feature point in the criterion image 31 by using the feature points detected from the criterion image 31 and the reference image 32, thereby detecting the corresponding points of the criterion image 31 and the reference image 32.

In the example shown in FIG. 9, the corresponding point detector 422 detects a feature point 32A in the reference image 32, which corresponds to a feature point 31A in the criterion image 31. That is, the corresponding point detector 422 detects the feature point 31A in the criterion image 31, and the feature point 32A in the reference image 32 as corresponding points. Similarly, the corresponding point detector 422 detects a feature point 32B in the reference image 32, which corresponds to a feature point 31B in the criterion image 31. That is, the corresponding point detector 422 detects the feature point 31B in the criterion image 31, and the feature point 32B in the reference image 32 as corresponding points. Similarly, the corresponding point detector 422 detects many corresponding points between the criterion image 31 and the reference image 32.

The registration module 423 subjects the reference image 32 to a projective transformation based on the detected corresponding points. More specifically, the registration module 423 calculates projective transformation coefficients for arranging the pixels in the reference image 32 at the same position as the corresponding pixels in the criterion image 31, respectively, by using the corresponding points. The registration module 423 then generates a transformed image (hereinafter also referred to as a projective transformation image) 33 obtained by subjecting the reference image 32 to a projective transformation based on the estimated projective transformation coefficients. That is, the registration module 423 determines pixels in the criterion image 31 and the corresponding pixels in the reference image 32 based on the transformation coefficients. By the projective transformation, as shown in FIG. 9, the glare 321 in the reference image 32 is transformed into glare 331 in the projective transformation image 33. Note that a region 332 in the projective transformation image 33 indicates a region in which pixels of the reference image 32 corresponding to the pixels of the projective transformation image 33 do not exist.

The glare detector 421 detects the glare 311 in the criterion image 31 and the glare 331 in the projective transformation image 33. More specifically, the glare detector 421 estimates whether a certain pixel in the image is involved with occurrence of flared highlights caused by the glare and calculates an evaluated value based on the estimated result. With respect to this evaluated value, the higher the possibility of occurrence of the flared highlights (the glare) is, for example, the smaller evaluated value will be set. The glare detector 421 calculates first evaluated values corresponding to the pixels in the criterion image 31, and calculates second evaluated values corresponding to the pixels in the projective transformation image 33 generated by transforming the reference image 32.

Further, as described above, process performed by the glare detector 421, the corresponding point detector 422 and the registration module 423 may already be carried out at the time of preview display. In that case, by using the processing result already obtained, similar processing which is performed after the reference image 32 has been acquired can be omitted.

Next, the composite image generator 43 generates the glare-reduced image 34 by combining the criterion image 31 and the projective transformation image 33 (that is, the reference image 32 subjected to projective transformation).

More specifically, the composite image generator 43 generates a weight map (alpha map) based on the calculated first evaluated values and the second evaluated values. Each of the first evaluated values indicates the degree of appropriateness of the pixel in the criterion image 31 to be used for combining the criterion image 31 and the projective transformation image 33 (that is, for generation of the composite image). Each of the second evaluated values indicates the degree of appropriateness of the pixel in the projective transformation image 33 to be used for combining the criterion image 31 and the projective transformation image 33. The weight map includes, for example, weights α for alpha-blending the projective transformation image 33 and the criterion image 31. The weight map includes a weight α assigned to a pixel in one of the two images. A weight α takes on values from 0 to 1, for example. In that case, the weight assigned to the pixel in the other image is (1-α).

At a position where the flared highlights are detected in the criterion image 31 (for example, when the first evaluated value is zero), the weight map is configured to reduce the weight assigned to the pixel (a pixel value) in the criterion image 31 and to increase the weight assigned to the pixel in the projective transformation image 33 obtained from the reference image 32. At a position where the flared highlights are detected in the projective transformation image 33 (for example, when the second evaluated value is zero), the weight map is configured to increase the weight assigned to the pixel in the criterion image 31 and to reduce the weight assigned to the pixel in the projective transformation image 33.

That is, the weight map is configured to make the weight assigned to the pixel (the pixel value) in the criterion image 31 heavier than the weight assigned to the pixel in the projective transformation image 33 when the first evaluated value is higher than the corresponding second evaluated value. The weight map is configured to make the weight assigned to the pixel in the criterion image 31 lighter than the weight assigned to the pixel in the projective transformation image 33 when the first evaluated value is lower than the corresponding second evaluated value. Further, the weight map is configured to make the weight assigned to the pixel in the criterion image 31 equal to the weight assigned to the pixel in the projective transformation image 33 when the first evaluated value is equal to the corresponding second evaluated value.

The composite image generator 43 generates the glare-reduced image (composite image) 34 by subjecting the criterion image 31 and the projective transformation image 33 obtained from the reference image 32 to a weighted addition (alpha-blending) based on the generated weight map. The composite image generator 43 generates the glare-reduced image 34 by, for example, calculating the sum of the pixel value of the pixel in the criterion image 31 which has been weighted by weight α and the pixel value of the corresponding pixel in the projective transformation image 33 which has been weighted by weight (1-α).

The composite image generator 43 further extracts an image corresponding to the clipping region 312 from the calculated glare-reduced image 34. Further, the composite image generator 43 generates an image 35 in which the glare is reduced and which is corrected to a rectangular shape by subjecting the extracted image to a distortion correction (rectangular correction). In this way, the user is able to view the image 35 in which the glare is reduced and which is corrected to a rectangular shape.

Then, the composite image generator 43 sets the glare-reduced image 34 (or the image 35 in which the glare is reduced and which is corrected to a rectangular shape) as a new criterion image 31. Further, based on a glare region in this new criterion image 31, for example, the notification generator 424 displays a region in a preview image corresponding to the glare region (i.e., a transformed glare region) in the preview image. Accordingly, by repeating the processing of acquiring the reference image 32 and reducing the glare in the criterion image 31 with this reference image 32, it becomes possible to gradually reduce the transformed glare region displayed in the preview image.

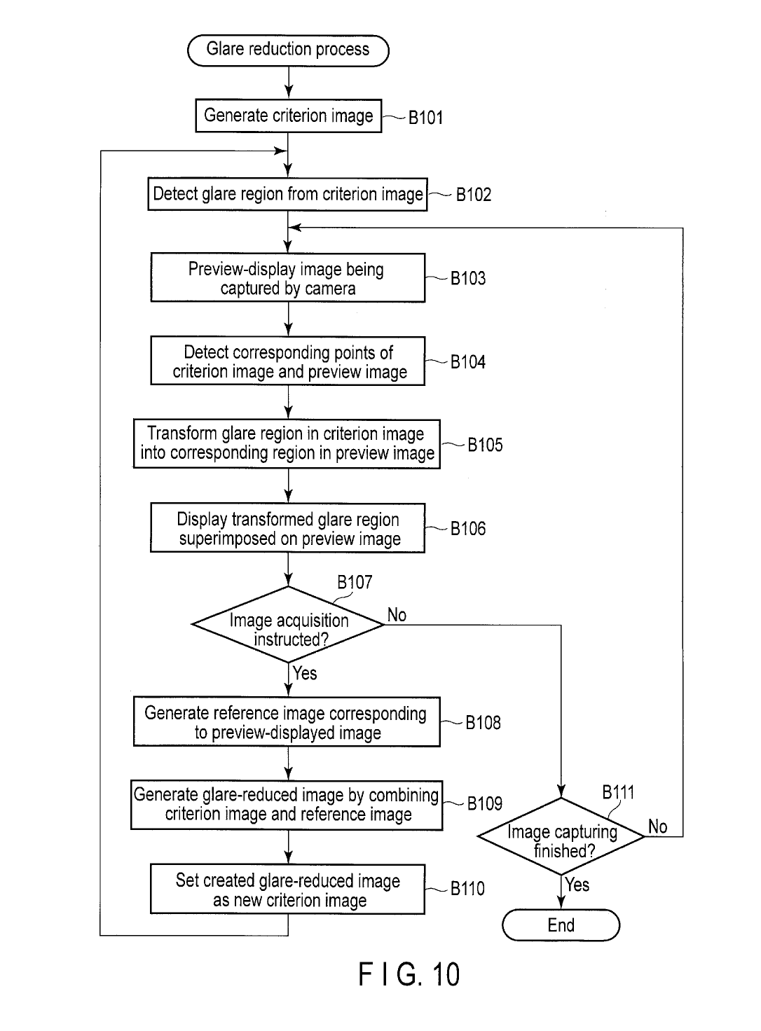

Next, with reference to the flowchart of FIG. 10, an example of the procedure of glare reduction process executed by the tablet computer 10 will be described.

Firstly, the camera module 109 generates the criterion image 51 (block B101). The glare detector 421 detects the glare region 511 from the criterion image 51 (block B102). Further, the preview processor 41 preview-displays the image (the preview image) 52 that is being captured by the camera module 109 on screen (block B103).

Next, the corresponding point detector 422 detects corresponding points of the criterion image 51 and the preview image 52 (block B104). Further, the notification generator 424 transforms the glare region 511 in the criterion image 51 into a corresponding region in the preview image 52 (hereinafter also referred to as a transformed glare region) (block B105), and displays the transformed glare region 522 which is superimposed on the preview image 52 (block B106).

Next, the camera module 109 determines whether capturing of the image which is being preview-displayed has been instructed or not (block B107). When the capturing of the image which is being preview-displayed has been instructed (Yes in block B107), the camera module 109 generates a reference image by using the image being preview-displayed (block B108).

The composite image generator 43 combines the criterion image 51 and the reference image, thereby creating a glare-reduced image (block B109). The composite image generator 43 registers the criterion image 51 and the reference image in cooperation with, for example, the glare detector 421, the corresponding point detector 422 and the registration module 423, and generates a glare-reduced image by alpha-blending the registered criterion image 51 and reference image. Further, the composite image generator 43 sets the generated glare-reduced image as a new criterion image (block B110).

Also, when the capturing of the image being preview-displayed has not been instructed (No in block B107), the preview processor 41 determines whether or not the image capturing (preview) should be finished (block B111). When the image capturing is not to be finished (No in block B111), the processing returns to block B103, and continues the superimposed display of the transformed glare region 522 on the new preview image 52. When the image capturing is to be finished (Yes in block B111), the processing is finished.

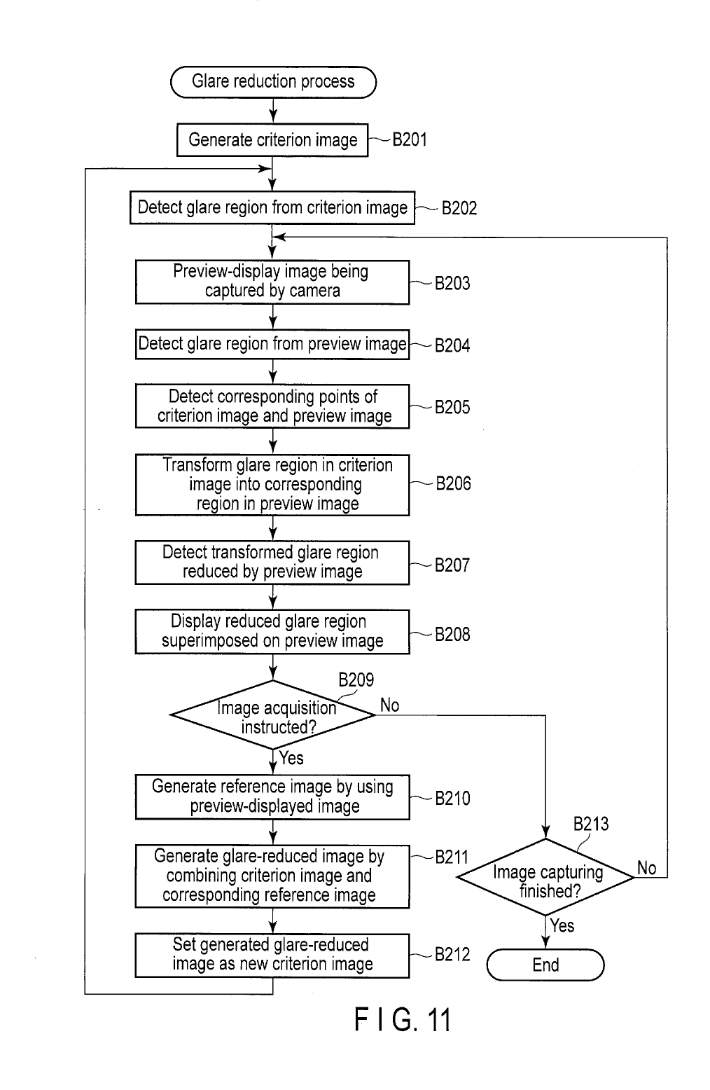

The flowchart of FIG. 11 shows another example of the procedure of glare reduction process.

Firstly, the camera module 109 generates the criterion image 61 (block B201). The glare detector 421 detects the glare region 611 from the criterion image 61 (block B202). Further, the preview processor 41 preview-displays the image (the preview image) 62 that is being captured by the camera module 109 on screen (block B203).

The glare detector 421 detects the glare region 621 from the preview image 62 (block B204). Next, the corresponding point detector 422 detects corresponding points of the criterion image 61 and the preview image 62 (block B205). The notification generator 424 transforms the glare region 611 in the criterion image 61 into a corresponding region in the preview image 62 (a transformed glare region) (block B206), and detects the region 622 in which the glare is reduced by the preview image 62 (block B207). That is, the notification generator 424 detects the region 622 which is not the glare region in the preview image 62 within the transformed glare region. Further, the notification generator 424 displays in the preview image 62 the region 622 in which the glare is reduced (block B208).

Next, the camera module 109 determines whether acquiring of the image which is being preview-displayed has been instructed or not (block B209). When the acquiring of the image which is being preview-displayed has been instructed (Yes in block B209), the camera module 109 generates a reference image by using the image being preview-displayed (block B210).

The composite image generator 43 combines the criterion image 61 and the reference image, thereby generating a glare-reduced image (block B211). The composite image generator 43 registers the criterion image 61 and the reference image in cooperation with the glare detector 421, the corresponding point detector 422 and the registration module 423, and generates a glare-reduced image by alpha-blending the registered criterion image 61 and reference image. Further, the composite image generator 43 sets the generated glare-reduced image as a new criterion image (block B212).

When the acquiring of the image being preview-displayed has not been instructed (No in block B209), the preview processor 41 determines whether or not the image capturing (preview) should be finished (block B213). When the image capturing is not to be finished (No in block B213), the processing returns to block B203, and continues the superimposed display of the region 622 in which the glare is reduced on the new preview image 62. When the image capturing is to be finished (Yes in block B213), the processing is finished.

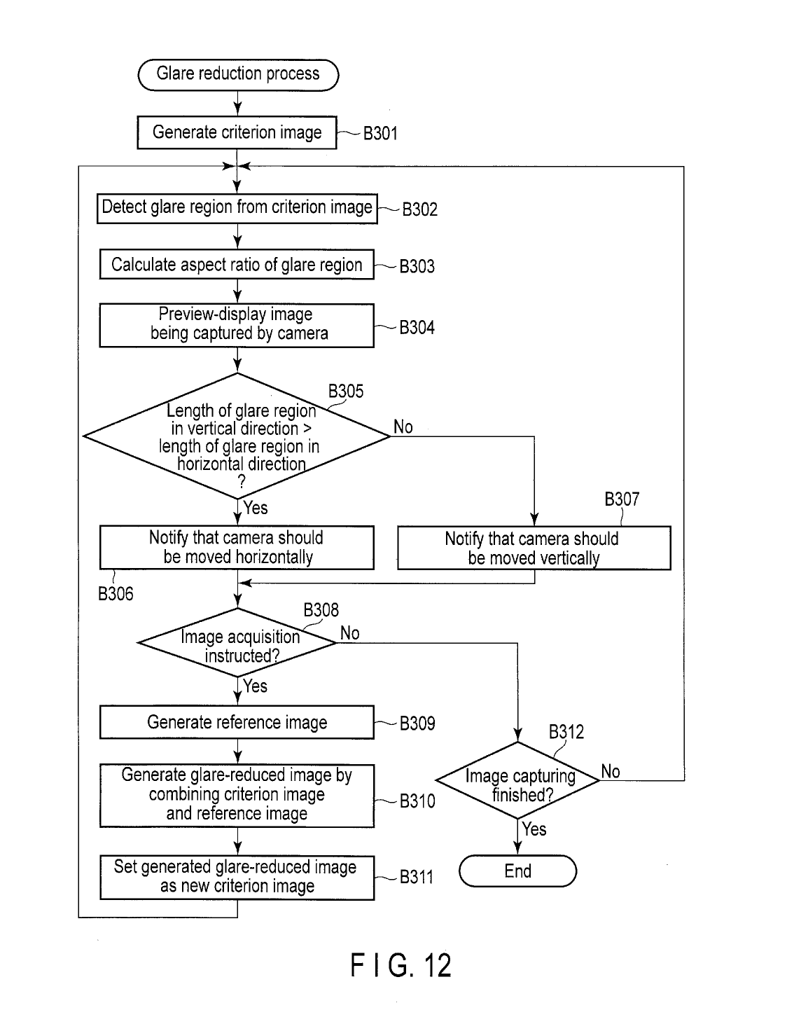

Next, by referring to the flowchart of FIG. 12, yet another example of the procedure of glare reduction process will be described.

Firstly, the camera module 109 generates the criterion image 71 (block B301). The glare detector 421 detects the glare region 711 from the criterion image 71 (block B302), and calculates an aspect ratio of the detected glare region 711 (block B303). The aspect ratio in this case is the ratio of, for example, the length of the edge in the vertical direction (the longitudinal direction) to the length of the edge in the horizontal direction (the lateral direction) of a rectangle circumscribing the glare region 711. Further, the preview processor 41 preview-displays the image (the preview image) 72 that is being captured by the camera module 109 on screen (block B304).

Next, the notification generator 424 determines whether or not the length of the glare region 711 in the vertical direction is greater than the length of glare region 711 in the horizontal direction (block B305). When the length of the glare region 711 in the vertical direction is greater than the length of it in the horizontal direction (Yes in block B305), the notification generator 424 notifies that the camera (the camera module) 109 should be moved horizontally (block B306). The notification generator 424 outputs voice from the speaker 18, for example, instructing that the camera should be moved horizontally. The notification generator 424 may display various kinds of GUI elements such as text or an image of an arrow on screen to instruct that the camera should be moved horizontally.

When the length of the glare region 711 in the vertical direction is less than or equal to the length of it in the horizontal direction (No in block B305), the notification generator 424 notifies that the camera (the camera module) 109 should be moved vertically (block B307). The notification generator 424 outputs voice from the speaker 18, for example, instructing that the camera should be moved vertically. The notification generator 424 may display various kinds of GUI elements such as text or an image of an arrow on screen to instruct that the camera should be moved vertically.

Next, the camera module 109 determines whether acquiring of the image which is being preview-displayed has been instructed or not (block B308). When the acquiring of the image which is being preview-displayed has been instructed (Yes in block B308), the camera module 109 generates a reference image by using the image being preview-displayed (block B309).

The composite image generator 43 combines the criterion image 71 and the reference image, thereby generating a glare-reduced image (block B310). The composite image generator 43 registers the criterion image 71 and the reference image in cooperation with the glare detector 421, the corresponding point detector 422 and the registration module 423, and generates a glare-reduced image by alpha-blending the registered criterion image 71 and reference image. Further, the composite image generator 43 sets the generated glare-reduced image as a new criterion image (block B311).

When the acquiring of the image being preview-displayed has not been instructed (No in block B308), the preview processor 41 determines whether the image capturing (preview) should be finished (block B312). When the image capturing is not to be finished (No in block B312), the processing returns to block B302, and continues the notification of the direction in which the camera should be moved during the display of the preview image 72. When the image capturing is to be finished (Yes in block B312), the processing is finished.

As described above, according to the present embodiment, it is possible to acquire an image for reducing the glare captured in the image efficiently. The glare detector 421 detects the glare region (first region) in which the glare has occurred from the criterion image which captures a subject. The notification processor 42 notifies information for determining a position for photographing the subject to the user based on the detected glare region when a preview image of the subject photographed with the camera module 109 is displayed on screen. In this way, since the user moves the camera module 109 in accordance with the notification, a reference image for acquiring the glare-reduced image can be efficiently obtained.

Note that the processing procedures of the present embodiment described with reference to the flowcharts of FIGS. 10 to 12 can all be executed by software. Accordingly, it is possible to easily realize an advantage similar to that of the present embodiment by simply installing a program for executing these processing procedures on an ordinary computer by way of a computer-readable storage medium having stored thereon the program, and executing this program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a processor configured to:
detect a first region of a first image where a glare occurs, the first image comprising a subject; and
notify a user of information based on the first region to determine a capturing position of the subject when a preview image of the subject captured with a camera is displayed on a screen.

2. The electronic apparatus of claim 1, wherein the processor is further configured to:
detect corresponding points between the first image and the preview image; and
transform the first region into a second region in the preview image based on the corresponding points; and
the electronic apparatus further comprises a display controller configured to display the second region in the preview image.

3. The electronic apparatus of claim 1, wherein the processor is further configured to:
detect corresponding points between the first image and the preview image;
detect a third region in the preview image where a glare occurs; and
transform the first region into a second region in the preview image based on the corresponding points; and
the electronic apparatus further comprises a display controller configured to display, in the preview image, a region where the second region and the third region do not overlap within the third region.

4. The electronic apparatus of claim 1, wherein the processor is further configured to:
detect corresponding points between the first image and the preview image;
detect a third region in the preview image where a glare occurs; and
transform the first region into the second region in the preview image based on the corresponding points; and
the electronic apparatus further comprises a display controller configured to display, in the preview image, a region where the second region and the third region overlap within the third region.

5. The electronic apparatus of claim 1, wherein the processor is configured to notify a direction in which the camera should be moved based on a shape of the first region.

6. The electronic apparatus of claim 5, wherein the processor is configured to notify a direction in which the camera should be moved based on an aspect ratio of the first region.

7. The electronic apparatus of claim 5, wherein the processor is configured to notify that the camera should be moved in a horizontal direction when a size of the first region in a vertical direction is larger than a size of the first region in the horizontal direction.

8. The electronic apparatus of claim 5, wherein the processor is configured to notify that the camera should be moved in a vertical direction when a size of the first region in the vertical direction is smaller than a size of the first region in a horizontal direction.

9. The electronic apparatus of claim 5, further comprises a sound controller configured to output voice indicative of the direction.

10. The electronic apparatus of claim 5, further comprises a display controller configured to display a text or an image indicative of the direction on the screen.

11. The electronic apparatus of claim 1, wherein the camera is configured to generate a second image of the subject captured in response to the user's instruction when the preview image is being displayed, and
the processor is further configured to:
detect corresponding points between the first image and the second image; and
generate a composite image based on pixels in the first image and corresponding pixels in the second image.

12. The electronic apparatus of claim 11, wherein the processor is configured to:
calculate a first evaluated value of each pixel in the first image;
calculate a second evaluated value of each pixel in the second image;
calculate a weight based on the first evaluated value of each pixel and the second evaluated value of corresponding each pixel; and
generate the composite image by adding each pixel in the first image to the corresponding each pixel in the second image based on the corresponding pair of weights.

13. The electronic apparatus of claim 12, wherein the processor is configured to:
calculate a transformation coefficient based on feature points in the first image and corresponding feature points in the second image; and
determine a pixel in the first image and a corresponding pixel in the second image based on the transformation coefficient.

14. A method of controlling notification comprising:
detecting a first region of a first image where a glare occurs, the first image comprising a subject; and
notifying a user of information based on the first region to determine a capturing position of the subject when a preview image of the subject captured with a camera is displayed on a screen.

15. A computer-readable, non-transitory storage medium having stored thereon a computer program which is executable by a computer, the computer program controlling the computer to execute functions of:
detecting a first region of a first image where a glare occurs, the first image comprising a subject; and
notifying a user of information based on the first region to determine a position of capturing the subject when a preview image of the subject captured with a camera is displayed on a screen.
